(19) United States
(12) Patent Application Publication
(10) Pub. No.: US 2017/0086382 A1
(43) Pub. Date: Mar. 30, 2017

(54) Mulching Assembly

(71) Applicants: Virger Brown, Houston, TX (US); Sandra Brown, Houston, TX (US)

(72) Inventors: Virger Brown, Houston, TX (US); Sandra Brown, Houston, TX (US)

(21) Appl. No.: 14/865,967

(22) Filed: Sep. 25, 2015

(51) Int. Cl. A01G 1/12; B02C 18/22; A01G 3/00

(52) U.S. Cl. CPC A01G 1/125; A01G 3/002; B02C 18/2225

(57) ABSTRACT

A mulching assembly includes a vacuum that may be positioned to facilitate the vacuum to suck debris from a support surface. A handle is coupled to the vacuum such that the handle may be gripped. A mulcher is coupled to the vacuum and the mulcher mulches the debris. A canister is provided that may be positioned on the support surface. The canister is fluidly coupled to the vacuum such that the canister may receive the mulched debris from the vacuum.

### BACKGROUND OF THE DISCLOSURE

### Field of the Disclosure

The disclosure relates to mulching devices and more particularly pertains to a new mulching device for mulching debris collected from a support surface.

### SUMMARY OF THE DISCLOSURE

An embodiment of the disclosure meets the needs presented above by generally comprising a vacuum that may be positioned to facilitate the vacuum to suck debris from a support surface. A handle is coupled to the vacuum such that the handle may be gripped. A mulcher is coupled to the vacuum and the mulcher mulches the debris. A canister is provided that may be positioned on the support surface. The canister is fluidly coupled to the vacuum such that the canister may receive the mulched debris from the vacuum.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a mulching assembly according to an embodiment of the disclosure.

FIG. 2 is a left side phantom view of an embodiment of the disclosure.

FIG. 3 is a cross sectional view taken along line 3-3 of FIG. 2 of an embodiment of the disclosure.

FIG. 4 is a front view of an embodiment of the disclosure.

FIG. 5 is a perspective in-use view of an embodiment of the disclosure.

FIG. 6 is a schematic view of an embodiment of the disclosure.

### DESCRIPTION OF THE PREFERRED EMBODIMENT

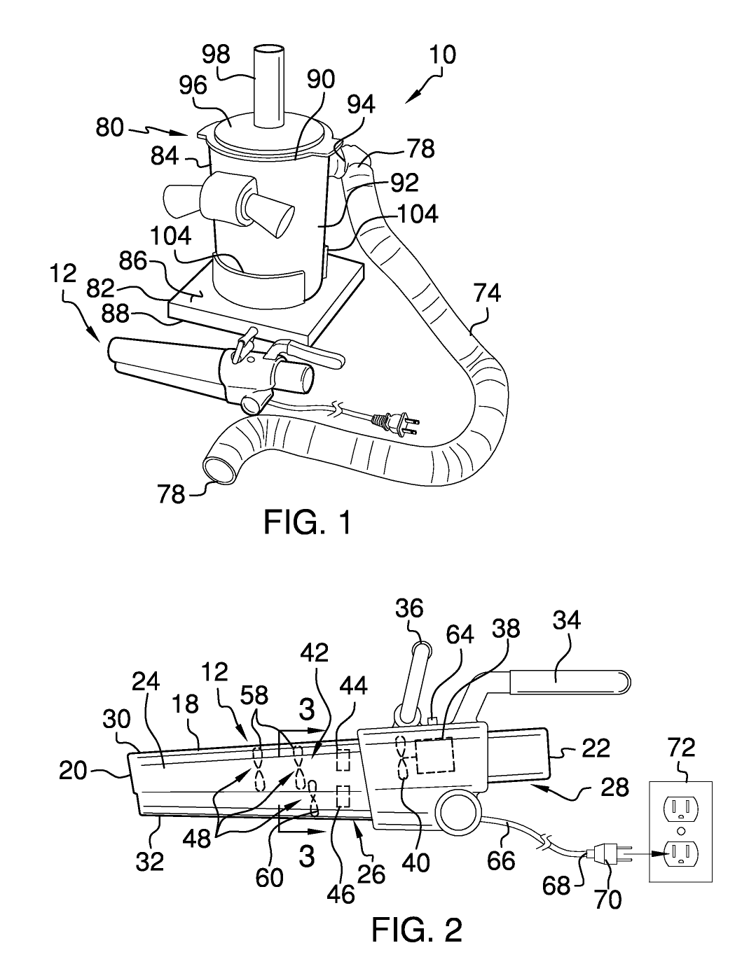

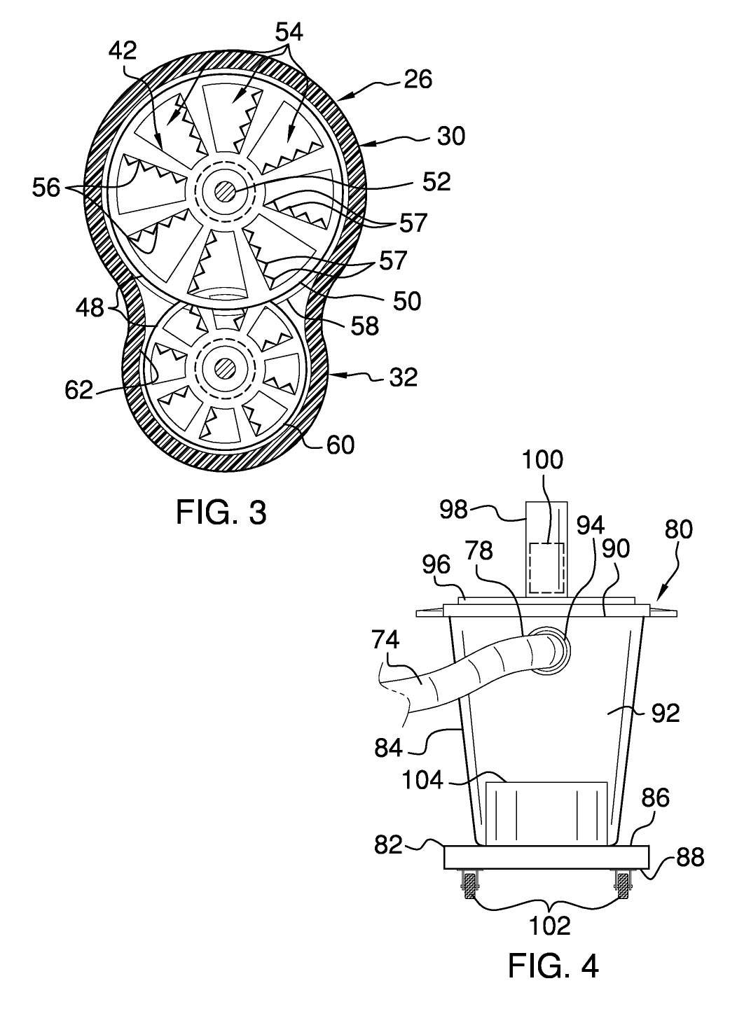

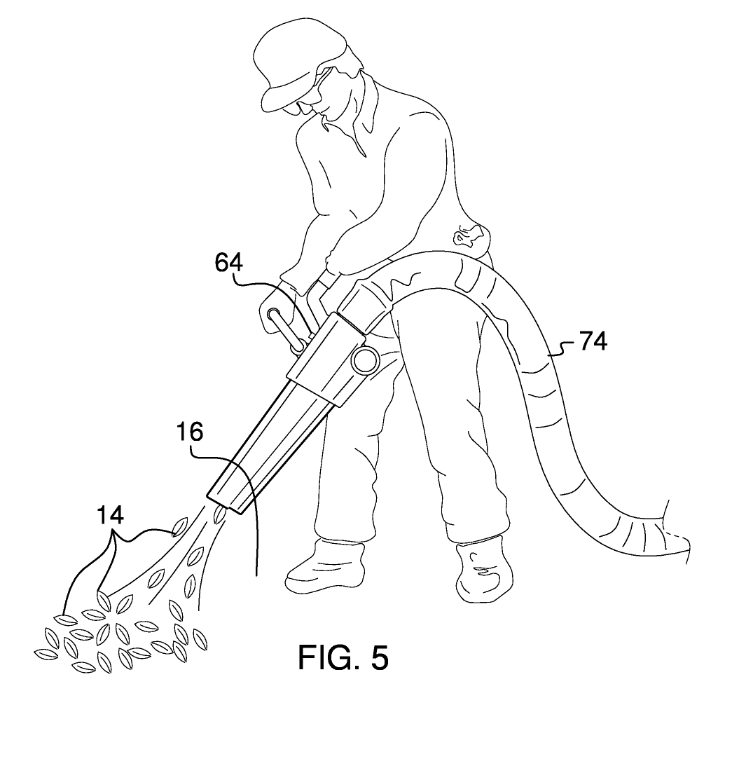

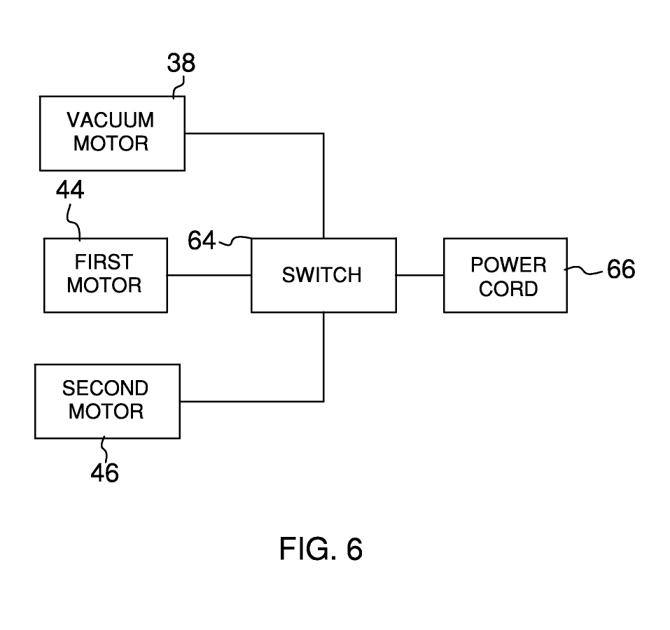

With reference now to the drawings, and in particular to FIGS. 1 through 6 thereof, a new mulching device embodying the principles and concepts of an embodiment of the disclosure and generally designated by the reference numeral 10 will be described.

As best illustrated in FIGS. 1 through 6, the mulching assembly 10 generally comprises a vacuum 12 that may be positioned to facilitate the vacuum 12 to suck debris 14 from a support surface 16. The debris 14 may be leaves and the support surface 16 may be ground. The vacuum 12 comprises a housing 18 that has a first end 20, a second end 22 and a peripheral wall 24 extending between the first end 20 and the second end 22. The first end 20 is open, the second end 22 is open and the housing 18 is substantially hollow.

The peripheral wall 24 is substantially cylindrical between the first end 20 and the second end 22 and the peripheral wall 24 has an intake section 26 and an exhaust section 28. The peripheral wall 24 corresponding to the intake section 26 has a top portion 30 and a bottom portion 32. The bottom portion 32 has a diameter that is less than a diameter of the top portion 30 such that the intake section 26 has a pear shaped cross section taken perpendicular to a line extending between the first end 20 and the exhaust section 28.

A handle 34 is coupled to the vacuum 12 such that the handle 34 may be gripped. The handle 34 is positioned on the peripheral wall 24 corresponding to the intake section 26. The handle 34 extends upwardly and rearwardly from the intake section 34. A grip 36 is provided and the grip 36 is movably coupled to the vacuum 12 such that the grip 36 may be gripped. The grip 36 is positioned on the peripheral wall 24 corresponding to the intake section 34. The grip 36 is oriented to be transverse to the handle 34 thereby enhancing manipulation of the vacuum 12.

The vacuum 12 further includes a vacuum motor 38 that is positioned within the intake section 26. The vacuum motor 38 may comprise an electrical motor or the like and the vacuum motor 38 is actuatable to rotate in a sucking direction and a blowing direction. A fan 40 is coupled to the vacuum motor 38 and the fan 40 is rotated when the vacuum motor 38 is turned on. Thus, the fan 40 urges air inwardly through the first end 20 and outwardly from the second end 22 when the vacuum motor 38 is actuated to rotate in the sucking direction. The fan 40 urges air inwardly through the second end 22 and outwardly through the first end 20 when the vacuum motor 38 is actuated to rotate in the blowing direction.

A mulcher 42 is coupled to the vacuum 12 and the mulcher 42 mulches the debris 14. The mulcher 38 comprises a first motor 44 that is positioned within top portion 30 of the intake section 26 and a second motor 46 that is positioned within the bottom portion 32 of the intake section 26. Each of the second 44 and third 46 motors may comprise an electrical motor or the like. A plurality of blades 48 is provided and each of the blades 48 has a peripheral edge 50 and a center 52. Each of the blades 48 has a plurality of openings 54 extending therethrough such that each of the blades 48 may allow air to pass therethrough. The openings 54 in each of the blades 48 extend between the center 52 and the peripheral edge 50 of an associated one of the blades 48. The openings 54 in each of the blades 48 are radially distributed around the center 52 of the associated blade 48.

Each of the openings 54 in each of the blades 48 has a cutting edge 56. The cutting edge 56 of each of the openings 54 in each of the blades 48 comprises a plurality of teeth 57. Thus, each of the blades 48 may mulch the debris 14. The plurality of blades 48 comprises a first set of blades 58 and a second set of blades 60. Each of the first set of blades 58 is rotatably positioned within the top portion 30 of the intake section 26 and each of the first set of blades 58 is spaced apart from each other. Each of the first set of blades 58 is rotatably coupled to the first motor 44 such that the first motor 44 rotates each of the first set of blades 58 when the first motor 44 is turned on.

Each of the second set of blades 60 is rotatably positioned within the bottom portion 32 of the intake section 26. Each of the second set of blades 60 is rotatably coupled to the second motor 46 such that the second motor 46 rotates each of the set of second blades 60 when the second motor 46 is turned on. Each of the first set of blades 58 is positioned a distance from the first end 20 that is less than a distance between the first end 20 each of the second set of blades 60. The peripheral wall 24 has an inside surface 62. The peripheral edge 50 of each of the blades 48 is positioned proximate the inside surface 62 thereby preventing the debris 14 from passing between the peripheral edge 50 of each of the blades 48 and the inside surface 62 of the peripheral wall 24.

A switch 64 is coupled to the housing 18 and the switch 64 is positioned on the peripheral wall 24 corresponding to the intake section 26. The switch 64 is electrically coupled to each of the vacuum motor 38, the first motor 44 and the second motor 46. The switch 64 is manipulated to actuate the vacuum motor 38 in either the sucking direction or the blowing direction. A power cord 66 is coupled to and extends away from the housing 18. The power cord 66 is electrically coupled to the switch 64 and the power cord 66 has a distal end 68 with respect to the housing 18. The distal end 68 has a plug 70 that is electrically coupled thereto and the plug 70 may be electrically coupled to a power source 72. The power source may comprise an electrical outlet or the like.

A hose 74 is provided that has a primary end 76 and a secondary end 78. The primary end 76 is removably coupled to the second end 22 of the housing 18 such that the hose 74 is in fluid communication with the fan 40. A canister 80 is provided that may be positioned on the support surface 16. The canister 80 is fluidly coupled to the vacuum 12 such that the canister 80 receives the mulched debris 14 from the vacuum 12.

The canister 80 has a base portion 82 and a container portion 84 and the base portion 82 has a bottom surface 86 and a top surface 88. The bottom surface 86 may abut the support surface 16 and the container portion 84 is coupled to and extends upwardly from the top surface 88. The container portion 84 has a distal end 90 with respect to the base portion 82. The distal end 90 of the container portion 84 is open and the container portion 84 is substantially hollow. The container portion 84 has an outer wall 92 and the outer wall 92 has an inlet 94 that is coupled thereto. The inlet 94 is in fluid communication with an interior of the container portion 84. The inlet 94 has the secondary end 78 of the hose 74 being fluidly coupled thereto such that the container portion 84 receives the mulched debris 14.

A lid 96 is removably coupled to the canister 80 and the lid 96 is positioned on the distal end 90 of the container portion 84. The lid 96 has a vent 98 and the vent 98 allows air to escape the canister 80. A filter 100 is positioned within the vent 98 such that the filter 100 prevents the mulched debris 14 from exiting the vent 98. A plurality of wheels 102 is rotatably coupled to the bottom surface 86 of the base portion 82. Each of the wheels 102 abuts the support surface 16 thereby facilitating the canister 80 to be rolled along the support surface 16. The container portion 84 is removable from the base portion 82 thereby facilitating the container portion 84 to be emptied when the container portion 84 becomes filled with the mulched debris 14. A pair of restraints 104 extends upwardly from the top surface 88 of the base portion 84. The restraints 104 are spaced apart from each other thereby facilitating the container portion 84 to be positioned between the restraints 104. Thus, each of the restraints 104 removably retains the container portion 84 on the base portion 84.

In use, each of the handle 34 and the grip 36 is gripped and the switch 64 is manipulated to actuate the vacuum motor 38 in the blowing direction or the sucking direction. Additionally, the switch 64 is manipulated to actuate the first motor 44 and the second motor 46. The first end 20 of the housing 18 is positioned to suctionally engage the debris 14 on the support surface 16 or the blow the debris on the support surface 16. The debris 14 is urged into the first end 20 of the housing 18 and the mulcher 42 mulches the debris. The mulched debris 14 is deposited into the container portion 84 of the canister 80. The container portion 84 is removed from the base portion 82 when the container portion 84 becomes filled with the mulched debris 14. The lid 96 is removed from the container portion 84 and the mulched debris 14 is emptied from the container portion 84.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mulching assembly configured to remove debris from a support surface and mulch the debris, said assembly comprising:
a vacuum configured to be positioned to facilitate said vacuum to suck debris from a support surface;
a handle being coupled to said vacuum wherein said handle is configured to be gripped;
a mulcher being coupled to said vacuum, said mulcher being configured to mulch the debris; and
a canister being configured to be positioned on the support surface, said canister being fluidly coupled to said vacuum wherein said canister is configured to receive the mulched debris from said vacuum.

2. The assembly according to claim 1, wherein said vacuum comprises a housing having a first end, a second end and a peripheral wall extending between said first end and said second end, said first end being open, said second end being open, said housing being substantially hollow, said peripheral wall being substantially cylindrical between said first end and said second end, said peripheral wall having an intake section and an exhaust section.

3. The assembly according to claim 2, wherein said peripheral wall corresponding to said intake section has a top portion and a bottom portion, said bottom portion having a diameter being less than a diameter of said top portion such that said intake section has a pear shaped cross section taken perpendicular to a line extending between said first end and said exhaust section.

4. The assembly according to claim 1, wherein:
said vacuum comprises a housing, said housing having a first end, a second end, an intake section and an exhaust section; and
said vacuum comprises a vacuum motor being positioned within said intake section.

5. The assembly according to claim 4, further comprising a fan being coupled to said vacuum motor, said fan being rotated when said vacuum motor is turned on wherein said fan is configured to urge air inwardly through said first end and outwardly from said second end.

6. The assembly according to claim 1, wherein
said vacuum comprises a housing, said housing having an intake section having a top portion and a bottom portion; and
said mulcher comprises:
a first motor being positioned within top portion of said intake section; and
a second motor being positioned within said bottom portion of said intake section.

7. The assembly according to claim 1, further comprising a plurality of blades, each of said blades having a peripheral edge and a center, each of said blades having a plurality of openings extending therethrough wherein each of said blades is configured to allow air to pass therethrough, said openings in each of said blades extending between said center and said peripheral edge of an associated one of said blades, said openings in each of said blades being radially distributed around said center of said associated blade.

8. The assembly according to claim 7, wherein:
each of said openings in each of said blades has a cutting edge, said cutting edge of each of said openings in each of said blades comprising a plurality of teeth wherein each of said blades is configured to mulch the debris; and
said plurality of blades comprising a first set of blades and a second set of blades.

9. The assembly according to claim 8, further comprising:
a first motor and a second motor;
said vacuum comprising a housing, said housing having an intake section and an exhaust section, said intake section having a top portion and a bottom portion; and
said first set of blades being rotatably positioned within said top portion of said intake section, each of said first set of blades being spaced apart from each other, each of said first set of blades being rotatably coupled to said first motor wherein said first motor rotates each of said first set of blades when said first motor is turned on.

10. The assembly according to claim 9, wherein each of said second set of blades is rotatably positioned within said bottom portion of said intake section, each of said second set of blades being rotatably coupled to said second motor wherein said second motor rotates each of said set of second blades when said second motor is turned on, each of said first set of blades being positioned a distance from said first end being less than a distance between each of said second set of blades and said first end.

11. The assembly according to claim 10, further comprising:
a vacuum motor;
said housing having a peripheral wall; and
a switch being coupled to said housing, said switch being positioned on said peripheral wall corresponding to said intake section, said switch being electrically coupled to each of said vacuum motor, said first motor and said second motor.

12. The assembly according to claim 11, wherein a power cord being coupled to and extending away from said housing, said power cord being electrically coupled to said switch, said power cord having a distal end with respect to said housing, said distal end having a plug being electrically coupled thereto, said plug being configured to be electrically coupled to a power source.

13. The assembly according to claim 1, further comprising:
said vacuum including a housing, said housing having a second end;
a fan; and
a hose having a primary end and a secondary end, said primary end being removably coupled to said second end of said housing such that said hose is in fluid communication with said fan; and

14. The assembly according to claim 1, wherein said canister has a base portion and a container portion, said base portion having a bottom surface and a top surface, said bottom surface being configured to abut the support surface, said container portion being coupled to and extending upwardly from said top surface.

15. The assembly according to claim 14, wherein said container portion has a distal end with respect to said base portion, said distal end of said container portion being open, said container portion being substantially hollow, said container portion having an outer wall, said outer wall having an inlet being coupled thereto, said inlet being in fluid communication with an interior of said container portion, said inlet having said secondary end of said hose being fluidly coupled thereto wherein said container portion is configured to receive the mulched debris.

16. The assembly according to claim 15, further comprising a lid being removably coupled to said canister, said lid being positioned on said distal end of said container portion, said lid having a vent, said vent being configured to allow air to escape said canister.

17. The assembly according to claim 16, further comprising a filter being positioned within said vent wherein said filter is configured to prevent the mulched debris from exiting said vent.

18. A mulching assembly configured to remove debris from a support surface and mulch the debris, said assembly comprising:
a vacuum configured to be positioned to facilitate said vacuum to suck debris from a support surface, said vacuum comprising:
a housing having a first end, a second end and a peripheral wall extending between said first end and said second end, said first end being open, said second end being open, said housing being substantially hollow, said peripheral wall being substantially cylindrical between said first end and said second end, said peripheral wall having an intake section and an exhaust section, said peripheral wall corresponding to said intake section having a top portion and a bottom portion, said bottom portion having a diameter being less than a diameter of said top portion such that said intake section has a pear shaped cross section taken perpendicular to a line extending between said first end and said exhaust section,
a vacuum motor being positioned within said intake section, and
a fan being coupled to said vacuum motor, said fan being rotated when said vacuum motor is turned on wherein said fan is configured to urge air inwardly through said first end and outwardly from said second end;
a handle being coupled to said vacuum wherein said handle is configured to be gripped, said handle being positioned on said peripheral wall corresponding to said intake section,
a mulcher being coupled to said vacuum, said mulcher being configured to mulch the debris, said mulcher comprising:
a first motor being positioned within top portion of said intake section,
a second motor being positioned within said bottom portion of said intake section,
a plurality of blades, each of said blades having a peripheral edge and a center, each of said blades having a plurality of openings extending therethrough wherein each of said blades is configured to allow air to pass therethrough, said openings in each of said blades extending between said center and said peripheral edge of an associated one of said blades, said openings in each of said blades being radially distributed around said center of said associated blade, each of said openings in each of said blades having a cutting edge, said cutting edge of each of said openings in each of said blades comprising a plurality of teeth wherein each of said blades is configured to mulch the debris, said plurality of blades comprising a first set of blades and a second set of blades, said first set of blades being rotatably positioned within said top portion of said intake section, each of said first set of blades being spaced apart from each other, each of said first set of blades being rotatably coupled to said first motor wherein said first motor rotates each of said first set of blades when said first motor is turned on, each of said second set of blades being rotatably positioned within said bottom portion of said intake section, each of said second set of blades being rotatably coupled to said second motor wherein said second motor rotates each of said set of second blades when said second motor is turned on, each of said first set of blades being positioned a distance from said first end being less than a distance between each of said second set of blades and said first end,
a switch being coupled to said housing, said switch being positioned on said peripheral wall corresponding to said intake section, said switch being electrically coupled to each of said vacuum motor, said first motor and said second motor, and
a power cord being coupled to and extending away from said housing, said power cord being electrically coupled to said switch, said power cord having a distal end with respect to said housing, said distal end having a plug being electrically coupled thereto, said plug being configured to be electrically coupled to a power source;
a hose having a primary end and a secondary end, said primary end being removably coupled to said second end of said housing such that said hose is in fluid communication with said fan; and
a canister being configured to be positioned on the support surface, said canister being fluidly coupled to said vacuum wherein said canister is configured to receive the mulched debris from said vacuum, said canister having a base portion and a container portion, said base portion having a bottom surface and a top surface, said bottom surface being configured to abut the support surface, said container portion being coupled to and extending upwardly from said top surface, said container portion having a distal end with respect to said base portion, said distal end of said container portion being open, said container portion being substantially hollow, said container portion having an outer wall, said outer wall having an inlet being coupled thereto, said inlet being in fluid communication with an interior of said container portion, said inlet having said secondary end of said hose being fluidly coupled thereto wherein said container portion is configured to receive the mulched debris;
a lid being removably coupled to said canister, said lid being positioned on said distal end of said container portion, said lid having a vent, said vent being configured to allow air to escape said canister; and
a filter being positioned within said vent wherein said filter is configured to prevent the mulched debris from exiting said vent.
